(19) United States
(12) Patent Application Publication
(10) Pub. No.: US 2005/0035714 A1
(43) Pub. Date: Feb. 17, 2005

(54) Electrode material for plasma display panel, manufacturing method of plasma display panel, plasma display device, and manufacturing method of same

(75) Inventor: Tomomi Hiraoka, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/914,138

(22) Filed: Aug. 10, 2004

(30) Foreign Application Priority Data
Aug. 11, 2003 (JP) 2003-291782

(51) Int. Cl. H01J 17/49

(52) U.S. Cl. 313/582

(57) ABSTRACT

An electrode material for a plasma display panel is provided which is capable of preventing an damage to an address electrode caused by a sandblast process while partition walls are formed. A front substrate on which surface-discharge electrodes are formed is arranged so as to face a rear substrate on which address electrodes are formed in a manner in which the address electrodes and the surface-discharge electrodes intersect each other and partition walls are formed in a manner to extend in parallel to the address electrodes. As an electrode material to form the address electrodes in a plasma display panel in which discharge cells are formed between the front substrate and rear substrate, a conductive paste or conductive sheet containing a conductive particle and glass frit and having sandblast resistance, which is higher than that in the partition wall portions, obtained after being baked is used.

### BACKGROUND OF THE INVENTION

1. Field of the Invention

The present invention relates to an electrode material for a plasma display panel using a conductive paste or conductive sheet containing a conductive particle and glass frit as the material for an address electrode, a method for manufacturing the above plasma display panel, a plasma display device and a manufacturing method for the plasma display device.

The present application claims priority of Japanese Patent Application No. 2003-291782 filed on Aug. 11, 2003, which is hereby incorporated by reference.

2. Description of the Related Art

In recent years, attention is being given to a plasma display panel (hereinafter being simply called a “PDP”) as a display panel being able to be thin and to be used in a form of a large display panel. A PDP is made up of a front plate and a rear plate in a manner in which the front plate having a transparent electrode, bus electrode, dielectric layer, protecting layer, and a like, all being formed on a glass substrate making up the front plate, faces the rear plate having an address electrode (being also called a “data electrode”), dielectric layer, rib (partition wall), phosphor layer, and a like, all being formed on another glass substrate making up the rear plate. Display cells making display for every pixel are formed in spaces being sealed with discharge gas partitioned by ribs which are located in an intermediate region between the front plate and rear plate, both facing each other. Plasma discharge is made to occur in the discharge gas by utilizing a potential between the bus electrodes, which generates an ultraviolet ray in the discharge gas and, by application of the generated ultraviolet ray to the phosphor layer, color display is made possible.

First, an outline of the plasma display device is described. FIG. 3 is a schematic block diagram showing configurations of a plasma display device 100 employed in a conventional technology and in the present invention. As shown in FIG. 3, the plasma display device 100 chiefly includes an analog interface 120 and a plasma display panel module 130. The plasma display module 130 includes a plasma display panel 150.

The analog interface 120 is made up of a Y/C (Y signal/Color signal) separating circuit 121 having a chroma decoder, an A/D (Analog/Digital) converting circuit 122, a synchronous signal controlling circuit 123 having a PLL (Phase-Locked-Loop) circuit, an image format converting circuit 124, a reverse γ (gamma) correcting circuit 125, a system controlling circuit 126, and a PLE (Peak Luminance Enhancement) controlling circuit 127. The analog interface 120 chiefly has a function of converting a received analog video signal to a digital signal and then feeding it to the plasma display panel module 130.

An input analog video signal is separated by the Y/C separating circuit 121 into luminance signals having a red (R) color, a green (G) color, and a blue (B) color and then is converted by the A/D converting circuit 122 into digital signals. After that, if a pixel configuration to be handled by the plasma display panel module 130 is different from that of a video signal, a necessary converting process of an image format is performed in the image format converting circuit 124. After the A/D (Analog/Digital) conversion of a video signal has been made in the A/D converting circuit 122, a reverse γ conversion is made on a video signal in the reverse γ (gamma) correcting circuit 125, and then a digital video signal reconstructed so as to have a linear characteristic is generated. The digital video signal generated as above is output to the plasma display panel module 130 as RGB (Red, Green, and Blue) video signals.

The PLL circuit (not numbered in FIG. 3) embedded in the synchronous signal controlling circuit 123 generates a sampling clock signal and a data clock signal by using a horizontal sync signal fed simultaneously with an analog video signal as a reference signal and then outputs them to the plasma display panel module 130. The PLE controlling circuit 127 in the analog interface 120 controls luminance on the plasma display panel 150. More specifically, the PLE controlling circuit 127 controls in a manner in which, when an average luminance level is a specified value or less, display luminance is increased and, when the average luminance level exceeds a specified value, the display luminance is decreased. The system controlling circuit 126 outputs various controlling signals to the plasma display panel module 130.

The plasma display panel module 130 is made up of a digital signal processing and controlling circuit 131, a panel section 132, and an in-module power circuit 133 internally having a DC/DC (Direct Current/Direct Current) converter. The digital signal processing and controlling circuit 131 has an input interface signal processing circuit 134, a frame memory 135, a memory controlling circuit 136, and a driver controlling circuit 137.

An average luminance level of a video signal input to the input interface signal processing circuit 134 is calculated by an input signal average luminance level operational circuit (not shown) in the input interface signal processing circuit 134 and the video signal having the calculated average luminance level is output as, for example, 5-bit data. Moreover, the PLE controlling circuit 127 sets PLE control data based on the average luminance level and feeds the set data to a luminance level controlling circuit (not shown) in the input interface signal processing circuit 134.

The input interface signal processing circuit 134 in the digital signal processing and controlling circuit 131, after having performed various signals, transmits a controlling signal to the panel section 132. At a same timing, the memory controlling circuit 136 transmits a memory controlling signal to the panel section 132 and the driver controlling circuit 137 transmits a driver controlling signal also to the panel section 132.

The panel section 132 is made up of a plasma display panel 150, a scanning driver 138 to drive a scanning electrode in the plasma display panel 150, a data driver 139 to drive a data electrode in the plasma display panel 150, high-voltage pulse circuits 140, 140 to apply a pulse voltage to the plasma display panel 150 and the scanning driver 138, and a power collecting circuit 141 to collect surplus power from the high-voltage pulse circuits 140, 140.

The plasma display panel 150 is constructed to have 1365 pixels×768 pixels. The scanning driver 138 in the plasma display panel 150 controls a scanning electrode and the data driver 139 controls a data electrode (address electrode) so that specified pixels are turned ON or OFF to display a desired image on a screen.

Next, an outline of a method for manufacturing the plasma display device shown in FIG. 3 is described. First, the panel section 132 is constructed by arranging the plasma display panel 150 fabricated according to a specified method of manufacturing a plasma display panel 150, scanning driver 138, the data driver 139, the high-voltage pulse circuits 140, 140 and power collecting circuit 141 on the substrate. Besides the panel section 132, the digital signal processing and controlling circuit 131 is mounted.

The plasma display panel module 130 is constructed by fabricating the panel section 132 configured as above, the digital signal processing and controlling circuit 131, and the in-module power circuit 133 as one module. Besides the plasma display panel module 130, the analog interface 120 is independently constructed.

Thus, after having constructed the analog interface 120 and the plasma display panel module 130 separately, both are electrically connected to each other to obtain the plasma display device 100 as shown in FIG. 3.

Next, a process of manufacturing a rear substrate of a conventional PDP is described by referring to FIG. 4. By coating a glass substrate 21 with a silver paste being a photosensitive paste on the glass substrate 21 using a screen printing method and processes of exposure, development, and baking are performed, two or more address electrodes 22 are formed. Then, by coating the two or more address electrodes 22 with a dielectric paste being a glass paste by using the screen printing method and are baked, a dielectric layer 23 is formed. Further, the dielectric layer 23 is coated with a rib paste being a glass paste by using the screen printing and a coater and is dried and then a dry film made of a photosensitive material is placed thereon to adhere thereto, and exposure and development processes are performed, and the dry film layer is made to be left in an area in which ribs are to be formed.

After that, in order to perform patterning on a rib layer (partition wall layer) 24 with a thickness of 100 μm to 200 μm, by using an impact generated by spraying powder-like particles such as alumina, silica (silicon dioxide), or a like from an air nozzle at an optimum pressure on the rib layer 24, the rib layer 24 having no dry film layer and being exposed is etched. The process of patterning on the rib layer 24 employed here is called a “sandblast method”. Finally, by coating each pixel region with phosphor pastes for each color, red, green and blue by using the screen printing, dispenser, or a like and drying and baking it, a phosphor layer 25 is formed.

The address electrodes 22 formed by the conventional manufacturing method is easily cut or peeled partially due to the impact generated by particles (hereafter being called “sandblast particles”) sprayed by the sandblast method, which causes breakage of wirings of the address electrode. To prevent this, the address electrodes 22 are covered with the dielectric layer 23 and a dry film consisting essentially of a photosensitive material is stuck to a portion of a wiring terminal and to a marker portion when the processes of exposure, development and patterning are performed so that these portions are coated in a protected manner. Moreover, another method of protecting the electrode is proposed in, for example, Japanese Patent Application Laid-open No. 2001-236881 in which an address electrode is coated with a dry film layer.

However, in the dielectric layer after having been baked, a missing or defective portion such as a pinhole in which a dielectric is partially missing, void in which a empty hole is left, or a like appears in some cases. Also, in the dry film layer that protects the terminal and/or marker portions, the missing or defective portion appears due to breakage or a like of the exposure mask being used in the exposure process in some cases. If such the missing or defective portion appears, the address electrode is exposed. In the process of forming the ribs, since sandblast particles are sprayed on the dielectric layer or on a surface of the dry film, the sandblast particles come into the collision with the exposed address electrode, thus causing breakage of wirings. Therefore, the method in which the address electrode is coated with the dielectric layer or dry film layer is not sufficient as an effective measure against the breakage of the wirings occurring in the sandblast process.

To solve the problem of the missing or defective portion in the dielectric layer, a method is disclosed in Japanese Patent Application Laid-open No. 2000-294141 in which an inspection is made on the dielectric layer after having been printed or baked and the detected missing or defective portion are repaired. However, this method, since the processes of making the inspection and of repairing the missing or defective portion have to be additionally employed, thus causing high costs, is not desirous. Moreover, when repairing of the missing or defective portion is needed, work of the drying using a laser following the coating with the glass paste is required, causing an increase in working time, which is not preferable.

It is thought that the damage of the electrode caused by the sandblast occurs due to a decrease in adherence strength between the address electrode and the glass substrate, which is caused by the impact of sprayed sandblast particles. The strength in adherence to the glass substrate of the electrode is mainly contributed by glass frit contained in the photosensitive paste. To solve this problem, an electrically conductive paste is disclosed in Japanese Patent Application Laid-open No. Hei 6-103810 in which, based on a study of components of the glass frit, strength of adherence of the conductive paste to terminals and/or substrates of electronic components or a like is not decreased during a plating process. Moreover, a photosensitive conductive paste obtained by studying a transition point, softening point, particle diameter, thermal expansion coefficient, component, or a like of the glass frit is disclosed in Japanese Patent Application Laid-open No. Hei 10-273338. However, such an electrode material for a PDP as strength in adherence of an electrode to a glass substrate is not decreased during the sandblast process has not yet been disclosed.

### SUMMARY OF THE INVENTION

In view of the above, it is an object of the present invention to provide a material for a PDP electrode being capable of solving a problem of a failure of wiring breakage during a sandblast process and of forming an address electrode whose strength in adherence to a glass substrate to be used in a PDP in particular is not decreased during the sandblast process, a method for manufacturing the above PDP, a plasma display device and a method for manufacturing the plasma display device.

According to a first aspect of the present invention, there is provided an electrode material for a plasma display panel for forming address electrodes in the plasma display panel in which a front substrate on which surface-discharge electrodes are formed is arranged so as to face a rear substrate on which address electrodes are formed in a manner in which the address electrodes and the surface-discharge electrodes intersect each other and ribs are formed in a manner to extend in parallel to the address electrodes and in which discharge cells are formed between the front substrate and the rear substrate, the electrode material including:

a conductive paste or conductive sheet containing a conductive particle and glass frit and having sandblast resistance obtained after being baked which is higher than that in rib portions.

In the foregoing, a preferable mode is one wherein a volume ratio of the conductive particle to glass frit contained in the conductive paste or conductive sheet is 100:2.0 to 40.0.

Also, a preferable mode is one wherein a weight ratio of the conductive particle to glass frit contained in the conductive paste or conductive sheet is 100:1.5 to 7.0.

Also, a preferable mode is one wherein the conductive paste or conductive sheet has photosensitivity and undergoes pattern exposure, development, and baking processes to form the address electrodes.

Also, a preferable mode is one wherein the conductive paste or conductive sheet has non-photosensitivity and undergoes screen printing and baking processes to form the address electrodes.

Also, a preferable mode is one wherein the conductive particle includes at least one selected from a group of silver (Ag), gold (Au), copper (Cu), platinum (Pt), nickel (Ni), ruthenium (Ru), palladium (Pd), and aluminum (Al).

Also, a preferable mode is one wherein the glass frit includes borosilicate frit containing at least one selected from a group of lead (Pb), bismuth (Bi), cadmium (Cd), barium (Ba), and calcium (Ca).

Also, a preferable mode is one wherein the glass frit includes alkaline-earth metal salt.

According to a second aspect of the present invention, there is provided a method for manufacturing a plasma display panel in which a front substrate on which surface-discharge electrodes are formed is arranged so as to face a rear substrate on which address electrodes are formed in a manner in which the address electrodes and the surface-discharge electrodes intersect each other and partition walls are formed in a manner to extend in parallel to the address electrodes and in which discharge cells are formed between the front substrate and rear substrate, the method including:

a process of forming the address electrodes on the rear substrate by using a specified electrode material, the specified electrode material including a conductive paste or conductive sheet containing a conductive particle and glass frit and having sandblast resistance obtained after being baked which is higher than that in the partition wall portions; and

a process of uniformly coating the rear substrate having the address electrode with a paste for forming partition walls in a tightly adhered manner and of drying and of performing a sandblast processing to form the partition walls.

According to a third aspect of the present invention, there is provided a plasma display device including:

a plasma display panel in which a front substrate on which surface-discharge electrodes are formed is arranged so as to face a rear substrate on which address electrodes are formed in a manner in which the address electrodes and the surface-discharge electrodes intersect each other and ribs are formed in a manner to extend in parallel to the address electrodes and in which discharge cells are formed between the front substrate and rear substrate; and

an interface to form a module by incorporating a circuit to drive the plasma display panel and to convert a format of an image signal and to transmit the converted format to the module;

wherein the plasma display panel is manufactured according to the method for manufacturing the plasma display panel described above.

According to a fourth aspect of the present invention, there is provided a method for manufacturing a plasma display device including:

a first process of manufacturing a plasma display panel;

a second process of manufacturing the plasma display panel and a circuit to drive the plasma display panel in a form of one module; and

a third process of electrically connecting an interface to convert a format of an image signal and to transmit the converted format to the module to the module;

wherein, in the first process, the method for manufacturing the plasma display panel described above is performed.

With the above configuration, since a conductive paste or conductive sheet being able to form an address electrode whose strength in adherence to a glass substrate is not decreased during the sandblast process, the problem of the failure of wiring breakage during the sandblast process in the manufacturing of a PDP can be solved.

### BRIEF DESCRIPTION OF THE DRAWINGS

The above and other objects, advantages, and features of the present invention will be more apparent from the following description taken in conjunction with the accompanying drawings in which:

FIGS. 1A to 1F are diagrams illustrating a method for forming an address electrode in a PDP according to a first embodiment of the present invention;

FIGS. 2A to 2E are diagrams illustrating a method for forming a rear substrate in a PDP according to a fifth embodiment of the present invention:

FIG. 3 is a schematic block diagram showing configurations of a plasma display device employed in a conventional technology and in the present invention; and

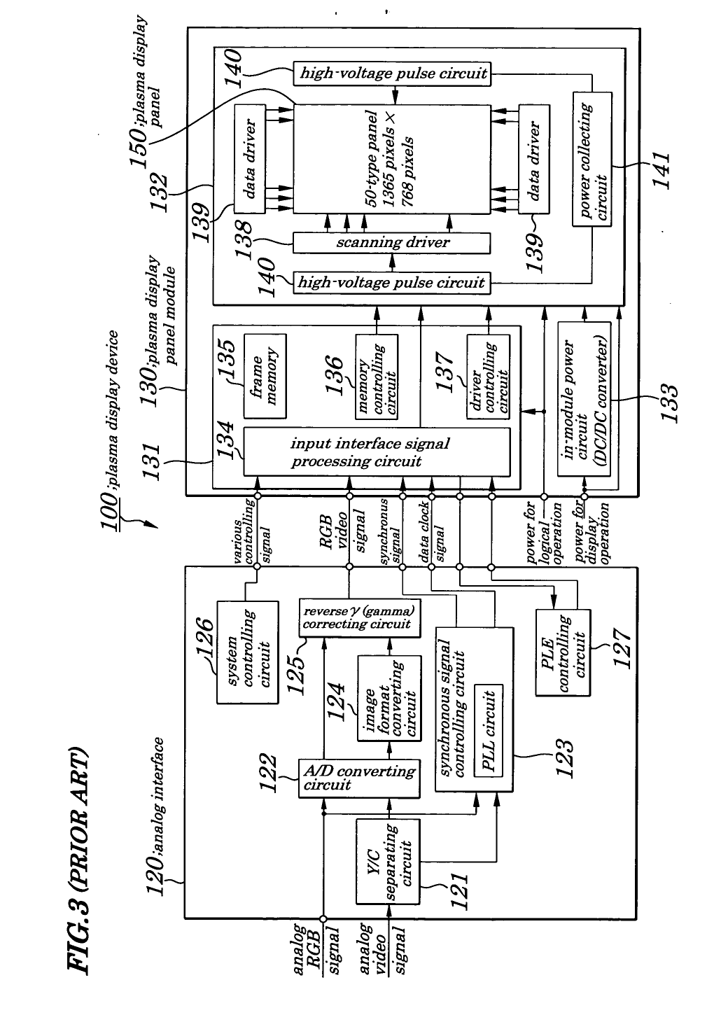

FIG. 4 is a diagram provided for explaining a process of manufacturing a rear substrate of a conventional PDP.

### DETAILED DESCRIPTION OF THE PREFERRED EMBODIMENTS

### Best Modes

Best modes of carrying out the present invention will be described in further detail using various embodiments with reference to the accompanying drawings.

To improve sandblast resistance of an address electrode, a conductive paste or conductive sheet serving as address electrode materials for a PDP of the present invention contains a conductive particle and glass frit and a volume ratio of the conductive particle to the glass frit is preferably 100:2.0 to 40.0 and a weight ratio of the conductive particle to the glass frit is preferably 100:1.5 to 7.0, which enables sandblast resistance of the address electrode to be improved over the conventional case.

The conductive particle contained in the conductive paste or conductive sheet includes, for example, metal particles such as silver (Ag), gold (Au), copper (Cu), platinum (Pt), nickel (Ni), ruthenium (Ru), palladium (Pd), aluminum (Al), or a like, and alloy particles or mixture containing these metal particles. Any one of the above metal particles may be employed singly or two or more metal particles may be employed in combination. Out of these conductive particles, the silver particle in particular is most preferable which is stable as the address electrode for the PDP and can provide excellent conductivity with comparative easiness and is reasonable in terms of costs. Also, the glass frit may include borosilicate frit containing at least one selected from a group of lead (Pb), bismuth (Bi), cadmium (Cd), barium (Ba), and calcium (Ca). Also, borate frit such as other alkaline-earth metal salt or a like is used in an ordinary case.

Generally, an address electrode made up of a conductive paste or conductive sheet is formed in a manner in which the conductive particle and glass frit are mixed. In the address electrode to be obtained in the present invention, by setting the volume ratio of the conductive particle to the glass frit to be 100:2.0 to 40.0, a decrease of strength in adherence to the glass substrate caused by collision with sandblast particles can be prevented most effectively. This is because if the volume ratio of the conductive particle to the glass frit is 100:40.0 or more, the glass frit is easily broken or peeled in an inner portion of the electrode by the impact of the sandblast particle and due to vulnerability of the glass frit portion in the electrode film. If the volume ratio of the conductive particle to the glass frit is 100:2.0 or less, even if no breakage occurs within the electrode, the address electrode is easily peeled or broken by the impact of the sandblast particle due to a decrease in strength in adherence to the glass substrate. Moreover, if the volume ratio of the conductive particle to the glass frit is 100:2.0 to 40.0, the weight ratio, when being calculated by using a specific gravity of the glass frit, of the conductive particle to the glass frit becomes 100:1.5 to 7.0.

### First Embodiment

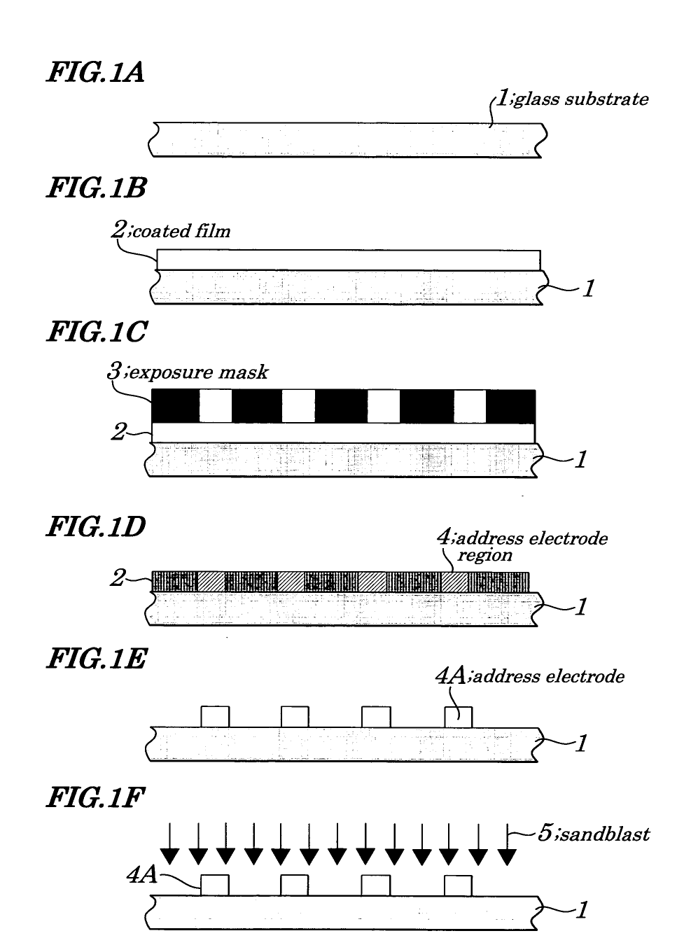

FIGS. 1A to 1F are diagrams illustrating a method for forming an address electrode 4A in a PDP of a first embodiment of the present invention. The method for forming the address electrode 4A in the PDP of the first embodiment and a method used in a comparative example for comparison are described by referring to FIG. 1. A photosensitive conductive paste employed in the embodiment is a photosensitive silver paste made up of a conductive particle containing silver and of glass frit containing silicon (Si), boron (B), bismuth (Bi), and lead (Pb).

In ordinary cases, formation of an address electrode 4A in a PDP uses four processes including (1) a process of electrode paste coating, (2) a process of electrode pattern exposure, (3) a process of electrode pattern development, and (4) a process of electrode pattern baking. These processes are explained in detail sequentially below.

(1) Process of Electrode Paste Coating

A glass substrate 1 (FIG. 1A) is coated with a photosensitive silver paste made up of silver particles and glass frit, in a manner in which a desired thickness is obtained, using a screen printer with a screen plate of 200 to 400 meshes. Then, by using an IR (Infrared Rays)—type drying furnace or a like, a coated film 2 printed on the glass substrate 1 is dried at a temperature of 150° C. or less (FIG. 1B).

(2) Process of Electrode Pattern Exposure

An exposure process is performed by irradiating the dried coated film 2 with an ultraviolet ray through an exposure mask 3 on which desired address electrode patterning has been performed by using an ultrahigh-pressure mercury lamp (FIG. 1C). As a result, a pattern region in the address electrode becomes an address electrode region 4 being irradiated with ultraviolet rays. Moreover, the electrode pattern generated through the exposure mask 3 to be used here is designed in a manner in which consideration is given to contraction by baking occurring when the address electrode 4A is baked.

(3) Process of Electrode Pattern Development

Since an alkaline-soluble organic resin is contained in the photosensitive silver paste, it is possible to perform the development process using an alkaline aqueous solution. In this case, any kind of alkaline aqueous solution can be used, however, in general, a sodium carbonate solution is used. In the embodiment, by performing a development process using a solution containing 0.5% by weight of sodium carbonate, an address electrode pattern is formed (FIG. 1D). A concentration of the sodium carbonate solution to be used for development is preferably within a range of 0.1 to 1.0 by weight-percentage. If the concentration of the sodium carbonate solution is 0.1 or less by weight-percent, it is too low for an electrode pattern to be formed and a residue is left, which causes a wiring short failure to occur easily. If the concentration of the sodium carbonate solution is 1.0 or more by weight-percent, excess development occurs, causing an exposure region to be easily peeled or broken and a wiring break to occur.

(4) Process of Electrode Pattern Baking

After completion of the developing process, a baking process is performed in an atmosphere at a peak temperature of 500° C. to 600° C. (FIG. 1E). If a baking temperature is 500° C. or less, an organic binder in a paste does not volatilize fully, causing a decrease in conductivity of an electrode. By performing each process as above, the address electrode 4A is formed on the glass substrate.

Results from evaluation on adherence strength of an address electrode 4A formed by using such the photosensitive conductive paste containing silver as described above, which is obtained during the sandblast processing, are described. The evaluation on the adherence strength is made by using sandblast time, as an index, required before the address electrode 4A is put into a state in which wirings of the address electrode 4A are broken while the process of sandblast 5 is performed (FIG. 1F) after the address electrode 4A has been formed on the glass substrate 1 by each of the processes shown in FIG. 1 without forming a dielectric layer, rib layer, and dry film.

Table 1 shows results of the evaluations on adherence strength of the address electrode 4A. Examples of the sandblast time required before the wirings for the address electrode 4A are broken while a ratio of the glass frit content is changed in the photosensitive conductive paste containing silver are explained below.

TABLE 1

| | sample 1 | sample 2 | sample 3* | sample 4* | sample 5* | sample 6 |
|---|---|---|---|---|---|---|
| ratio of glass frit | 80 | 60 | 40 | 6 | 2 | 1 |
| content | | | | | | |
| (volume ratio of silver | | | | | | |
| 100 to glass frit) | | | | | | |
| address electrode | 100 | 100 | 100 | 100 | 100 | 100 |
| width [μm] | | | | | | |
| sandblast particle | glass beads | glass beads | glass beads | glass beads | glass beads | glass beads |
| jetting pressure | 1.0 | 1.0 | 1.0 | 1.0 | 1.0 | 1.0 |
| [kgf/cm²] | | | | | | |
| sandblast time | 10 | 15 | 60 | 100 | 80 | 20 |
| required before | | | | | | |
| wiring for address | | | | | | |
| electrode is broken | | | | | | |
| [minutes] | | | | | | |

In Table 1, the sandblast time required before wirings of the address electrode 4A are broken indicates a sandblast-resistant characteristic of each of the address electrodes 4A formed by using the photosensitive silver paste containing the glass frit at each containing ratio corresponding to each sample number. Also, in Table 1, the sample numbers with a (*) mark show the number of each of the samples employed in the embodiment of the present invention and other sample numbers show the number of comparative samples.

A cutting characteristic of a sandblast depends on a material for a sandblast particle, spraying pressure (jetting pressure) of sandblast particles, and a material for a rib (not shown). For example, in the case of the rib material having high hardness, optimization of the cutting characteristic is achieved by making the jetting pressure comparatively high or by making the sandblast time longer, with the jetting pressure being kept constant. In the embodiment, by using glass beads as the sandblast particles and by fixing jetting pressure to be 1.0 Kgf/cm², the sandblast-resistant characteristic of the electrode is compared. As is apparent from Table 1, even if the address electrodes 4A having the sample numbers 3, 4, and 5, as employed in the embodiment, are sandblasted by three times longer than the address electrodes 4A having the sample numbers 1, 2, 6, or a like, peeling or breaking in the address electrodes 4A did not occur. Also, Table 1 shows that, in the case of the address electrode 4A having the sample number 4 in particular, our test results show that peeling or breaking are most likely not to occur in the address electrodes 4A.

Moreover, though not shown in Table 1, when the jetting pressure is set to be 2 Kgf/cm² or more, the sandblast time required before wirings of the address electrodes 4A having the sample numbers 1 to 6 are broken is shortened, however, the address electrodes 4A having the sample numbers 3 to 5 were the same least easily peeled in terms of its tendency. That is, the tendency in which the address electrodes 4A having the sample numbers 3 to 5 are less easily broken or peeled during the sandblasting process has nothing to do with cutting conditions applied in the sandblasting process.

Observations of a cross section of the address electrode 4A after having undergone the sandblast process show that the glass frit existing in internal portions of the address electrode 4A having the sample numbers 1 and 2 was crushed by collision with the sandblast particles and cracks occurred in the glass frit existing in an interface between the glass substrate and address electrode 4A, which caused the address electrode 4A to be peeled easily. Also, according to the observation, in the address electrodes 4A having the sample number 6, though there occurred no breaking of the glass frit within the electrode, the strength in adherence of the address electrodes 4A to the glass substrate became low due to small amounts of the glass frit, which caused cracks to occur easily in the interface between the glass substrate and address electrode 4A, and peeling or breaking of the address electrode 4A was seen. In the address electrodes 4A having the sample numbers 3 to 5, though a crash of the address electrode 4A was seen by the collision with the sandblast particles, cracks did not occur easily in the interface between the glass substrate and address electrode 4A and the crash of the glass frit in the internal portion of the address electrode 4A was not seen.

As is apparent from the above results, the volume ratio of the conductive particle to the glass frit is an important element to improve the sandblast-resistant characteristic of the address electrode 4A. That is, by adjusting the volume ratio of the conductive particle to the glass frit so as to be 100:2.0 to 40.0, the sandblast-resistant characteristic can be improved more effectively compared with the conventional case.

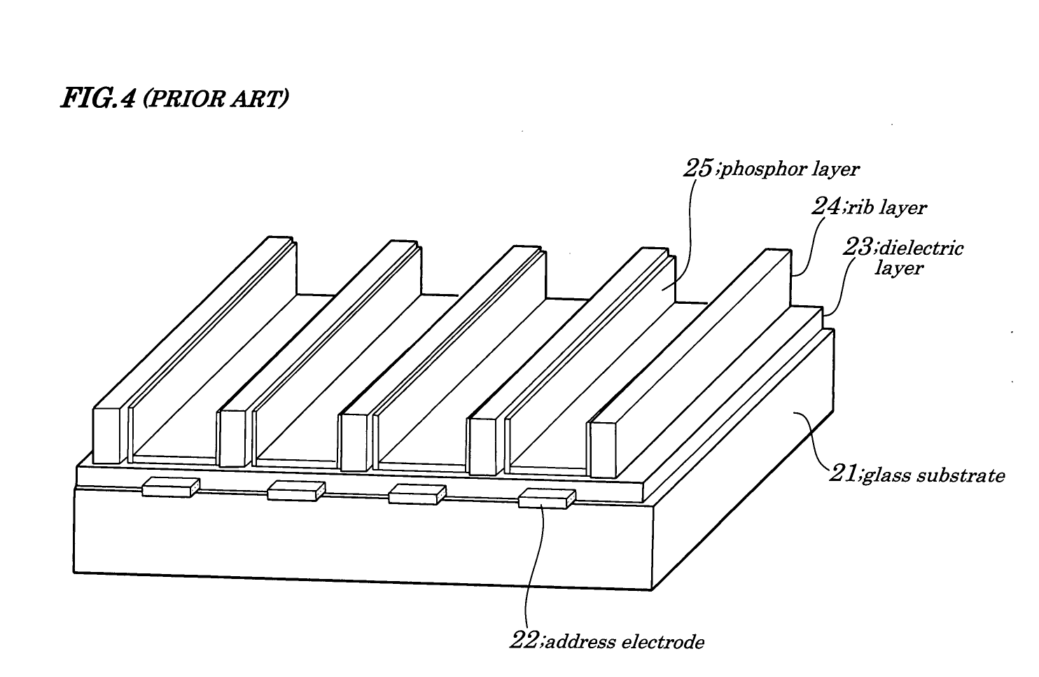

Thus, according to the address electrode 4A using the photosensitive conductive paste of the first embodiment as its material, since sandblast resistance of the address electrode 4A, which is required when the sandblast process is performed to form ribs, can be enhanced, unlike in the case of the conventional PDP shown in FIG. 4, even if no dielectric layer is formed on the address electrode 4A, it is possible to prevent a damage to the address electrode 4A caused by the sandblast process. Therefore, in the first embodiment, the number of manufacturing processes at the time of fabrication of the rear substrate in the PDP can be reduced, which contributes to reduction in costs for manufacturing the PDP.

### Second Embodiment

In the first embodiment, as the material for the address electrode, the photosensitive silver paste is used. However, in the second embodiment, as the material for the address electrode, a photosensitive conduction paste is used which is made of a metal particle including any one of gold, copper, platinum, nickel, ruthenium, palladium, aluminum, or a like, or an alloy particle or mixture obtained by a combination of at least one selected from these metals and silver, and having a specified mixture ratio therein. In the second embodiment, the same effect obtained in the first embodiment can be realized. The processes of manufacturing the address electrodes of the second embodiment are the same as employed in the first embodiment.

### Third Embodiment

In the first and second embodiments, as the material for the address electrode, the conductive paste having photosensitivity is used. However, in the third embodiment, a conductive paste having no photosensitivity is employed. In the third embodiment, the same effect as obtained in the first embodiment can be achieved as well. In the fabrication process of the address electrode in the third embodiment, the conductive paste is printed by using a screen plate on which an electrode pattern is formed in advance so that the patterning of the address electrode is performed on a glass substrate, and then the address electrode, after having been baked, is fixed on the glass substrate.

### Fourth Embodiment

In the first and second embodiments, as the material for the address electrode, the conductive paste having photosensitivity is used. However, in the fourth embodiment, the address electrode is fabricated by using a photosensitive conductive sheet containing a conductive particle and glass frit. In this method, the same effect as obtained in the first embodiment can be achieved. In the process of fabricating the address electrode of the third embodiment, by sticking the conductive sheet to the glass substrate and by performing exposure and development processes, after pattern of the address electrode has been formed on the glass substrate, a baking process is performed to fix the address electrode on the glass substrate.

### Fifth Embodiment

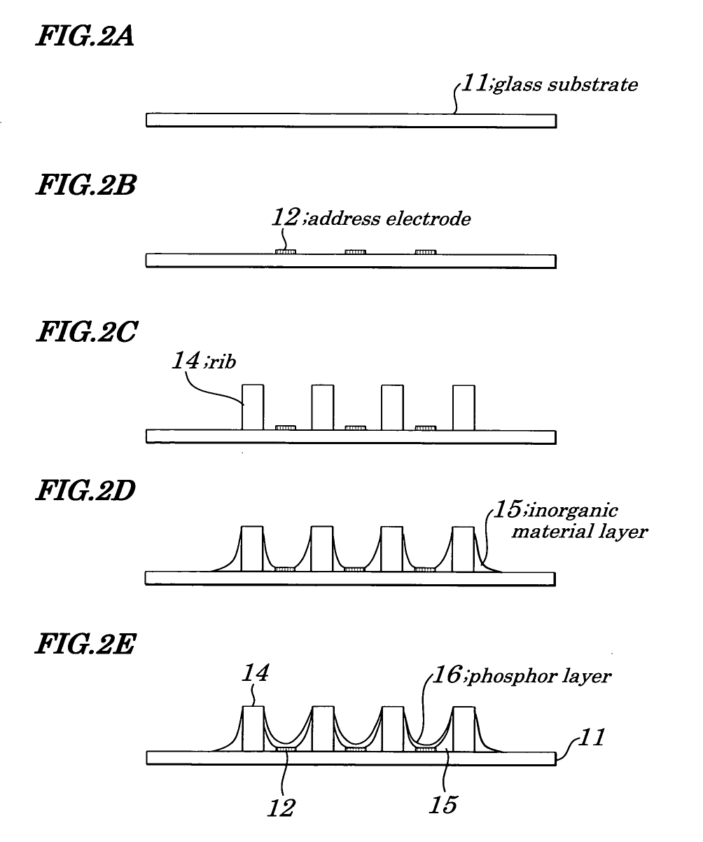

FIG. 2 is a diagram provided for illustrating a method for forming a rear substrate in a PDP of a fifth embodiment of the present invention. Each process employed in the method for forming the rear substrate in the PDP of the fifth embodiment will be described below.

First, a glass substrate 11 as shown in FIG. 2A is coated with, for example, a photosensitive silver paste containing a silver particle and glass frit as a photosensitive electrode material as in the case of the first embodiment and is then dried. Next, an exposure process is performed on the coated photosensitive conductive paste containing silver to obtain a specified pattern and a development process using an alkaline developing solution is performed and, as shown in FIG. 2B, an address electrode 12 is formed. In order to fix the address electrode 12 formed thus on the glass substrate 11, a baking process is performed to have the pattern of the address electrode 12 hardened by being baked on the glass substrate 11.

Next, by coating the glass substrate 11 uniformly with a rib forming paste and performing a drying process, a photosensitive dry film is laminated thereon. Then, the photosensitive dry film is photosensitized through a glass mask by using the specified pattern and the glass substrate 11 is then cooled. Further, by developing the photosensitive dry film having undergone the exposure process using the alkaline developing solution and removing the dry film not being exposed and then performing a sandblast process, as shown in FIG. 2C, ribs 14 are formed in a portion where the dry film is left.

After the formation of the ribs 14, as shown in FIG. 2D, all entire sides of the ribs 14 are coated with a paste containing a white inorganic fine particle as the main component and are dried. Further, a phosphor material for each color is painted sequentially on sides of each of the ribs 14, dried and then baked. This causes the ribs 14 to be hardened by being baked and, at the same time, both the inorganic material and phosphor material to be hardened by being baked and, as a result, the inorganic material layer 15 and phosphor layer 16 are formed. Moreover, the inorganic material layer 15 has an effect of increasing a reflection rate and improving luminance of the PDP, however, its formation may be omitted.

Thus, according to the formation method of the rear substrate of the PDP of the fifth embodiment, by using the photosensitive silver paste containing the silver particle and glass frit, unlike in the conventional case, even if the dielectric layer is not formed on the address electrode, the sandblast process for formation of the ribs 14 can be performed without causing an damage to the address electrode and, therefore, the number of processes of manufacturing the PDP can be decreased and costs for the manufacturing can be reduced.

It is apparent that the present invention is not limited to the above embodiments but may be changed and modified without departing from the scope and spirit of the invention. For example, the PDP of the present invention may be suitably applied to display devices for a television, however, the present invention is not limited to this and may be applied to other applications.

The conductive particle may include at least one selected from a group of silver (Ag), gold (Au), copper (Cu), platinum (Pt), nickel (Ni), ruthenium (Ru), palladium (Pd), and aluminum (Al)

1. An electrode material for a plasma display panel for forming address electrodes in said plasma display panel in which a front substrate on which surface-discharge electrodes are formed is arranged so as to face a rear substrate on which address electrodes are formed in a manner in which said address electrodes and said surface-discharge electrodes intersect each other and partition walls are formed in a manner to extend in parallel to said address electrodes and in which discharge cells are formed between said front substrate and said rear substrate, said electrode material comprising:
a conductive paste or conductive sheet containing a conductive particle and glass frit and having sandblast resistance obtained after being baked which is higher than that in the partition wall portions.

2. The electrode material for the plasma display panel according to claim 1, wherein a volume ratio of said conductive particle to glass frit contained in said conductive paste or conductive sheet is 100:2.0 to 40.0.

3. The electrode material for the plasma display panel according to claim 1, wherein a weight ratio of said conductive particle to glass frit contained in said conductive paste or conductive sheet is 100:1.5 to 7.0.

4. The electrode material for the plasma display panel according to claim 1, wherein said conductive paste or conductive sheet has photosensitivity and undergoes pattern exposure, development, and baking processes to form said address electrodes.

5. The electrode material for the plasma display panel according to claim 1, wherein said conductive paste or conductive sheet has non-photosensitivity and undergoes screen printing and baking processes to form said address electrodes.

6. The electrode material for the plasma display panel according to claim 1, wherein said conductive particle comprises at least one selected from a group of silver (Ag), gold (Au), copper (Cu), platinum (Pt), nickel (Ni), ruthenium (Ru), palladium (Pd), and aluminum (Al).

7. The electrode material for the plasma display panel according to claim 1, wherein said glass frit comprises borosilicate frit containing at least one selected from a group of lead (Pb), bismuth (Bi), cadmium (Cd), barium (Ba), and calcium (Ca).

8. The electrode material for the plasma display panel according to claim 1, wherein said glass frit comprises alkaline-earth metal salt.

9. A method for manufacturing a plasma display panel in which a front substrate on which surface-discharge electrodes are formed is arranged so as to face a rear substrate on which address electrodes are formed in a manner in which said address electrodes and said surface-discharge electrodes intersect each other and partition walls are formed in a manner to extend in parallel to said address electrodes and in which discharge cells are formed between said front substrate and rear substrate, said method comprising:
a process of forming said address electrodes on said rear substrate by using a specified electrode material, said specified electrode material comprising a conductive paste or conductive sheet containing a conductive particle and glass frit and having sandblast resistance obtained after being baked which is higher than that in the partition wall portions; and
a process of uniformly coating said rear substrate having said address electrode with a paste for forming partition walls in a tightly adhered manner and of drying and of performing a sandblast processing to form said partition walls.

10. The method for manufacturing a plasma display panel according to claim 9, wherein a volume ratio of said conductive particle to glass frit contained in said conductive paste or conductive sheet is 100:2.0 to 40.0.

11. The method for manufacturing a plasma display panel according to claim 9, wherein a weight ratio of said conductive particle to glass frit contained in said conductive paste or conductive sheet is 100:1.5 to 7.0.

12. The method for manufacturing a plasma display panel according to claim 9, wherein said conductive paste or conductive sheet has photosensitivity and undergoes pattern exposure, development, and baking processes to form said address electrodes.

13. The method for manufacturing a plasma display panel according to claim 9, wherein said conductive paste or conductive sheet has non-photosensitivity and undergoes screen printing and baking processes to form said address electrodes.

14. The method for manufacturing a plasma display panel according to claim 9, wherein said conductive particle comprises at least one selected from a group of silver (Ag), gold (Au), copper (Cu), platinum (Pt), nickel (Ni), ruthenium (Ru), palladium (Pd), and aluminum (Al).

15. The method for manufacturing a plasma display panel according to claim 9, wherein said glass frit comprises borosilicate frit containing at least one selected from a group of lead (Pb), bismuth (Bi), cadmium (Cd), barium (Ba), calcium (Ca).

16. The method for manufacturing a plasma display panel according to claim 9, wherein said glass frit comprises alkaline-earth metal salt.

17. A plasma display device comprising:
a plasma display panel in which a front substrate on which surface-discharge electrodes are formed is arranged so as to face a rear substrate on which address electrodes are formed in a manner in which said address electrodes and said surface-discharge electrodes intersect each other and partition walls are formed in a manner to extend in parallel to said address electrodes and in which discharge cells are formed between said front substrate and rear substrate; and
an interface to form a module by incorporating a circuit to drive said plasma display panel and to convert a format of an image signal and to transmit the converted format to said module;
wherein said plasma display panel is manufactured according to the method for manufacturing the plasma display panel as stated in claim 9.

18. A method for manufacturing a plasma display device comprising:
a first process of manufacturing a plasma display panel;
a second process of manufacturing said plasma display panel and a circuit to drive said plasma display panel in a form of one module; and
a third process of electrically connecting an interface to convert a format of an image signal and to transmit the converted format to said module to said module;
wherein, in said first process, the method for manufacturing the plasma display panel as stated in claim 9 is performed.
